(19) United States
(12) Patent Application Publication
(10) Pub. No.: US 2022/0366813 A1
(43) Pub. Date: Nov. 17, 2022

(54) MODELMAKING SYSTEM FOR DESIGNING BUILDINGS

(71) Applicant: Michael SHAW, Upper Coomera, Queensland (AU)

(72) Inventor: Michael SHAW, Upper Coomera, Queensland (AU)

(21) Appl. No.: 17/765,682

(22) PCT Filed: Sep. 24, 2020
(86) PCT No.: PCT/AU2020/051014

§ 371 Date: Mar. 31, 2022

(30) Foreign Application Priority Data
Oct. 8, 2019 (AU) 2019246777

(51) Int. Cl. G09B 25/04; A63H 33/04

(52) U.S. Cl. CPC G09B 25/04; A63H 33/044

(57) ABSTRACT

A parts library apparatus of predesigned freestanding three dimensional box like forms representing modest room sized units, each complete with a floor, walls and a roof of a particular shape and pitch and further categorised as either room units with full height walls and lower pitched roofs, or loft units with higher pitched roofs and some short wall or no wall sides, together with three types of unit assembly defined as non-core, core, or a combination of both, so that by selecting a kit of parts containing at least one type of unit from the parts library, a user can assemble them in accordance with at least one of the three types of unit assembly to form at least one model building and building design which can be easily reconfigured to produce many alternative design options.

### TECHNICAL FIELD

In particular this invention relates to an adaptable modelmaking system using space defining modules to design buildings.

### BACKGROUND

Physical models are sometimes used during the building design process to test or communicate ideas or for final presentation and marketing. Many people are not skilled at drawing or imagining objects and have difficulty visualising 3D buildings from elevations and floor plans. An accurate wellmade physical model provides a better perspective than drawings or computer generated 3D modelling images which try to give the illusion of three dimensions on a two dimensional surface. For this reason, 3D modelling images are not easy to relate to and can be difficult to understand. However, while physical models are easier to comprehend, they can be costly to produce, difficult to modify, and being single purpose will probably be discarded afterwards.

In addition to single purpose model buildings used by professional designers various demountable and reusable construction kits are commercially available mainly for hobbyists and children's toys. There are 3D puzzle model building kits, which cannot be modified, made up of interlocking parts, producing a single purpose model, usually a souvenir of a famous building or building type. There are also other kits which are multipurpose, and modifiable, and concerned mainly with how to connect the parts. One kit uses very small hollow plastic bricks connected by tubular studs with which the user can create somewhat unrealistic models of almost anything. Another kit with a modern design approach has modular floor, wall, and roof pieces which require connection by pegs in holes.

At present there are opposing schools of design amongst building design professionals. Modernists ‘start with the floor plan, and work from the inside out’ emphasising internal layout based on functional requirements which may change over time, whereas traditionalists favour ‘roof plan down, and working from the outside in’ emphasising the more permanent parts of the building such as the structure and ‘skin’.

Contemporary buildings are conceived mainly as highly specialised finished products rather than an activity that changes over time with the needs of the user. At present there are many specialised types of buildings including residential, commercial, industrial, health, education, and religion which are designed ‘not’ to adapt to change even though usages in and around them are constantly changing. All buildings grow and go through many changes during their life cycle and finally completing a new building is an illusion because no building works well in the beginning. The more specialised they are the more difficult they are to reshape. Every building is gradually transformed by the people who occupy them over time. Everyone has their own ideas and sometimes the expensive improvement is worse than what it replaced. Bad design decisions can adversely affect future growth and lifespan. Low roof eaves and concealed roof trusses inhibit horizontal and vertical growth and complexity greatly increases construction and maintenance costs, flat roofs tend to leak, fixed internal walls may be difficult to relocate and services may be hard to access. The building trades use design for demolition trade practices instead of recycling and reuse, generating a large solid waste burden at demolition, meanwhile the building owner is encouraged to borrow money to build more now and pay a lot more later on as interest and to cover construction cost blowouts and excessive claims due to construction changes. On top of all this the maintenance, operating costs and changes made during a buildings lifetime could cost several times more than the original building cost.

Change in buildings is inevitable and different parts change at different rates. Floor plans change most frequently especially in commercial buildings. Services such as electrical, plumbing, heating and ventilation, air conditioning and lifts, change less frequently, whereas the structure and building envelope are least subject to change.

The contemporary approach contrasts with vernacular or traditional buildings where plans are not required and buildings are designed to grow incrementally, room by room, as circumstances permit, with modest multipurpose spaces and connectively between rooms.

This invention is concerned mainly with the building shell, using a small unit as the design and plan module to create designs which are pleasant to be in, adaptable, practical and economical to maintain, relying on natural lighting and ventilation, passive heating and cooling, easy to build in stages, add on to and expand, fully utilising the enclosed volume under the roof, providing general purpose space, standardised rooms and relocatable interior walls where possible and encouraging self-help and community participation in the design and construction process, making buildings more affordable.

Generally a design concept is required before a model can be made, but this invention allows the user to experiment, design a building and make a model at the same time. The model can be easily modified as the design evolves enabling the user to visualise the next stage by what is already there and to study multiple design options. Finally, the model can be quickly disassembled for future reuse. Instead of “making a model based on a design” the user can “make a design based on a model”.

### SUMMARY

A modelmaking system for designing buildings in accordance with this invention comprises:

(a) A parts library apparatus including a plurality of individual three dimensional box like space defining forms representing modest room sized units, each unit complete with a square or rectangular floor, walls at right angles to the floor, and a roof with a shape selected from the group consisting of a flat shape, a lean-to shape, a gable shape, a hip shape, a valley shape, and a cross shape, and a roof pitch selected from the group consisting of very low pitch, low pitch, medium pitch, high pitch, and steep pitch, the units may be further categorised as either room units, with optional flat or raking ceilings, very low to medium pitched roofs, and full height walls at least one storey high, or loft units with raking ceilings and medium to steep pitched roofs, the lowest parts of which connect either to short walls or directly to the floor on at lease on side or corner;

(b) Three types of unit assembly of which
(1) Is a non-core unit assembly of maximum height one and a half storeys in which the lowest part of the roof is about one storey or less above ground level on at least one side of the assembly;
(2) Is a core unit assembly in which the external walls are at least sufficiently high all the way around to easily accommodate non-core add-on units and non-core extension units by wall to wall surface contact;
(3) Is a combination of core and non-core assemblies; and

(c) A kit of parts comprising a plurality of at least one type of unit selected from said parts library and assembled by a user in accordance with at least one of said three types of unit assembly to produce at least one model building and building design.

Preferably the modelmaking apparatus may further include part room sized units including quarter, half, and three quarter sized units, and larger room sized units including one and a half and two and a quarter sized units, which are vertical subdivisions and multiples respectively, of the basic horizontal module, the modest room sized unit to give greater flexibility in room size and shape.

Preferably the modelmaking apparatus may further include a flat full room height extender unit with variable height short walls representing wall heights ranging from about 0.6 metres to about 1.5 metres, to enable increased wall and ceiling heights, suspended ground floor support, split levels, roof continuity and the adjustment of room proportions while minimising the proliferation of individual unit types.

Preferably the modelmaking apparatus may further include the following parts library units with alternative additional features comprising:
(a) a half room unit with a diagonal wall and a room unit with a curved quadrant wall in the flat roof category;
(b) a half gambrel compound roof loft unit in the lean-to category together with related compound roof loft units in the hip and valley roof categories;
(c) a low pitched diagonally truncated cuboid loft unit in the lean-to category and a diagonally truncated cuboid room unit in the gable category;
(d) pyramid, half pyramid, and truncated pyramid room units with polygon bases in the quarter pyramid hip roof category;
(e) units with gable roofs intersecting lean-to roofs in the cross roof category.

Preferably the modelmaking apparatus may further include units with roofs categorised as curved, the group comprising: a barrel loft unit, a segmental arch room unit, a pointed arch loft unit, a lean-to loft unit, and a quadrant lean-to loft unit, whereby the curvatures in loft units provide increased headroom compared to pitched roofs.

The modelmaking apparatus may further include a range of dormer window roof accessory units for medium to steep pitched roofs with roof shapes selected from the group containing a flat shape, a gable shape, a lean-to shape, a hip shape, and a curved shape.

Preferably the modelmaking system is modular with the horizontal module in plan represented by the modest room sized unit for smaller buildings and a structural bay for larger buildings and the vertical module in section and elevation represented by a modest floor to floor height of one storey.

Possibly, the size of units for a scale model could be about one fiftieth full size with the basic horizontal module representing an average width or length of about 3.6 metres which could be scaled up and down to represent a range of full size room widths or lengths starting at about 2.4 metres and increasing in 300 mm increments up to about 4.5 metres or more, with structural bay sizes approximately double those sizes. The vertical module could remain substantially constant with an average height of about 2.7 metres. A modest size room could be in the approximate range of eleven to fourteen square metres.

The approximate roof pitches range from very low, about five degrees; to low, about fifteen degrees; to medium, about thirty degrees; to high, about forty five degrees; to steep, about fifty five degrees.

Preferably the units are hollow box like forms with wall openings for windows, doors, and other apertures which may vary on different sides whereby the assembled units could be horizontally rotated to reveal alternative exterior openings thus minimising the number of unit types.

In use, in the assembled condition the independent free standing units are unconnected, contiguous and able to be stacked horizontally wall to wall and vertically from ground or base level one on top of the other up to roof level, whereby the units have the capacity for easy demountability, disassembly and reuse.

In a combination unit assembly a non-core add-on unit can be defined as having at least part or all of its roof sloping down and away at right angles from a core wall it abuts whereas a non-core extension unit which projects out at right angles from a core assembly can be defined as having a roof which slopes down parallel to said core wall.

A plurality of non-core add-on units can partially or completely surround a core assembly whereas non-core extension units cannot, and if an add on assembly or extension assembly is above one and a half storeys high it becomes a core add-on or core extension and forms part of said core assembly.

The unit floors and walls inside an assembled model building represent a modular grid of aisles and bays with load bearing columns at or near the internal corners of units but they do not necessarily determine the actual placement of walls, floors, columns, and beams and may be used as a guide for the intended structure and floor plan arrangement. Large span trusses may be required to replace beams and columns where unobstructed open space is required.

Roofs of units are shown without overhangs although they are permitted and depending of the purpose of the model and how the units are made they can be incorporated as an additional feature.

Units may be manufactured by lasercutting wood, plywood, metal, cardboard, paper and foam, or by plastic injection mould or 3D printing. The actual full sized building based on the model could be made of whatever material and construction system is deemed appropriate and possible materials could include bamboo, wood, mud, stone, brick, metal, glass, and concrete.

Possibly the assembly and the parts thereof are provided in the form of virtual entities in a computer program whereby the same process of design using an adaptable model can be performed on a computer.

A method of designing buildings using a modelmaking system comprising:
(a) Providing a parts library apparatus including a plurality of individual scale model three dimensional box like space defining forms representing modest room sized units or structural bays, each complete with a square or rectangular floor, walls at right angles to the floor, and a roof with a shape selected from the group containing flat, lean-to, gable, hip, valley and cross, and a roof pitched selected from the group containing very low, low, medium, high, and steep, the units being further categorised as either room units, with optional flat or raking ceilings, very low to medium pitched roofs, and full height walls at least one storey high, or loft units with raking ceilings and medium to steep pitched roofs, the lowest parts of which connect either to short walls or directly to the floor on at least one side or corner;
(b) selecting a plurality of at least one type of unit from the parts library to be defined as a kit of parts;
(c) deciding on whether to assemble the kit of parts by physical model, computer, or hand drawing;
(d) providing three types of unit assembly of which:
   (1) is a non-core unit assembly of maximum height one and a half storeys in which the lowest part of the roof is about one storey or less above ground level on at least one side of the assembly;
   (2) is a core unit assembly in which the external walls are at least sufficiently high all the way around to easily accommodate non-core add-ons and extensions by wall to wall surface contact;
   (3) is a combination of core and non-core assemblies and
(e) Using at least one of the three types of unit assembly to produce at least one model building and building design.

### OBJECTS AND ADVANTAGES

(1) A user friendly system to make to the design process of ordinary buildings easier, quicker and more accessible to anyone. Drawing ability or knowledge of computer draughting is not necessary.
(2) A straight forward scientific and educational process which can improve the users' imagination, aesthetic appreciation and problem solving skills.
(3) Depending on the types of units selected by the user, designs can range from simple to complex, for example, from a simple single storey building of prismatic shape using a small variety of units and few rooms with either a flat, lean-to, or gable roof to a complicated multi storey building with add-ons and extensions and many rooms made from a large variety of units and a multi pitched roof using hip, valley, cross or curved shapes.
(4) Although the model buildings are modular with many apparent joints it is not necessary for the proposed full size building to be modular or to have exposed joints.
(5) The modular nature of the units allows for easy exploration of alternative design possibilities.
(6) The space plan and services can be worked out while the model is evolving or after the shell has been finalised using the grid of room sized units as a guide.
(7) Many contemporary buildings are very wide, relying on artificial lighting and air conditioning. This system encourages narrower building wings, roof lights, courtyards, natural lighting and cross ventilation.
(8) To further personalise design outcomes custom made forms can be specially designed to be combined with units from the parts library which is non exhaustive.
(9) The individual units and the three types of unit assembly are designed to allow a building to grow incrementally room by room making it easy to construct a building in stages while looking complete at each stage.

### BRIEF DESCRIPTION OF DRAWINGS

The invention will be more clearly understood from the following description of some embodiments thereof, given by way of example only with reference to the accompanying drawings in which:

Page 1/5 shows a parts library including on the left hand side a vertical column of individual unit types based on roof shape, FIG. 1A to FIG. 6A, each with a full room sized footprint, minimum full height walls and various low to medium pitched roofs with the exception of FIG. 1A which has a very low pitch flat roof and further including FIG. 7B which has a curved roof.

Various related units with the same figure number but different alphabetical suffixes are in adjacent horizontal rows. Room types are either room units or loft units. Room units have low to medium pitch roofs and units with the letter ‘L’ inside are loft units with either curved or medium to steep roof pitch. The loft enables steep roofs to become useful, it eliminates wasted roof space, and short loft walls can accommodate additions and extensions.

FIG. 1A to FIG. 1F are perspective views of units categorised as ‘flat’ with full height walls at least one storey high except for FIG. 1D. The top surfaces can represent either a flat roof with very low pitch or a flat floor/ceiling. FIG. 1A is a cuboid room unit. FIG. 1B is a cuboid half room unit. FIG. 1C is a cuboid quarter room unit. FIG. 1D is a cuboid unit with short walls of adjustable height. FIG. 1E is a half room unit with a triangular footprint. FIG. 1F is a room unit with a quarter circle footprint.

FIG. 2A to FIG. 2G are perspective views of units categorised as ‘lean-to’ defined as a one way single sloping roof. FIG. 2A is a basic room unit. FIG. 2B is a half room unit. FIG. 2C is a quarter room unit. FIG. 2D is a half loft unit with a steep roof pitch and one short wall. FIG. 2E is a loft unit with a high pitch roof connected to the floor on one side with the capacity for increased height using FIG. 1D (dotted). FIG. 2F is a loft unit with a compound roof combining steep and low to medium pitches in a half gambrel shape with capacity for increased height using FIG. 1D (dotted) underneath. FIG. 2G is a diagonally truncated cuboid loft unit with an unusual low pitch roof.

FIG. 3A to FIG. 3E are perspective views of units categorised as ‘gable’ in which the roof slopes down in opposite directions from a horizontal ridgeline. FIG. 3A is a room unit. FIG. 3B is a half room unit. FIG. 3C is a steep pitched loft unit with two short walls on opposite sides. FIG. 3D is an ‘A’ frame loft unit similar to FIG. 3C but with roof extending to the floor on opposite sides. The footprint being one and a half times modest room size. FIG. 3E is a diagonally truncated cuboid room unit.

FIG. 4A to FIG. 4G are perspective views of units categorised as ‘hip’ which, according to the inventor's definition refers to the sloping ridge formed when two lean to roofs meet at right angles on an external corner. The roof shapes are either a quarter, half or full pyramid sitting on four sided bases. FIG. 4A is a room unit with a quarter pyramid roof on top of a cuboid base. FIG. 4B is a quarter room unit with a quarter pyramid roof on a cuboid base. FIG. 4C is a three quarter room unit with a truncated quarter pyramid ‘wraparound’ hip roof on a base with an ‘L’ shaped footprint. FIG. 4D is a room unit with a pyramid roof on a cuboid base. FIG. 4E is a half room unit with a half pyramid roof on a rectangular cuboid base. FIG. 4F is a loft unit with a high pitched quarter pyramid roof with no walls on two adjacent sides where the roof connects directly to the floor, with the capacity for increased height using FIG. 1D underneath (dotted). FIG. 4G is a loft unit with a quarter pyramid compound ‘mansard’ roof which has a low to medium pitch upper roof combined with a steep pitch lower roof connecting to the floor on two adjacent sides, with increased height capacity using FIG. 1D underneath.

FIG. 5A to FIG. 5D are perspective views of units categorised as ‘valley’ which refers to the sloping valley gutter formed when two lean-to roofs meet at right angles on an internal corner. FIG. 5A is a valley roofed room unit. FIG. 5B is a valley roofed quarter room unit. FIG. 5C is a high pitched valley roofed loft unit in which the roof connects with the floor at a corner with increased height capacity shown dotted. FIG. 5D is a loft unit with a compound valley ‘mansard’ roof as per FIG. 4G connecting to the floor at one corner with increased height capacity shown dotted.

FIG. 6A to FIG. 6H are perspective views of units categorised as ‘cross or intersecting’ roofs and sometimes as ‘cross gables’ in which roofs intersect at right angles. In some cases, a lean-to roof intersects with a gable or the intersecting roofs may have different pitches. FIG. 6A is a room unit with a cross gable roof. FIG. 6B is a low pitch lean-to room unit intersected by a low pitch gable roof. FIG. 6C is a medium pitch lean-to loft unit with one short wall intersected by a medium pitch gable room unit. FIG. 6D is a lean-to high pitch loft unit intersected by a steep pitch gable with increased height capacity. FIG. 6E is a loft unit with cross gable steep pitch roof. FIG. 6F shows a medium pitch gable roof intersecting a lean-to steep pitch half loft unit. FIG. 6H is an enlarged ‘A’ frame loft unit intersected by a gable steep pitched loft unit. The footprint being two and a quarter times modest room size.

FIG. 7A to FIG. 7E are perspective views of units with roofs categorised as ‘curved’. FIG. 7A is a barrel roofed loft unit with short walls on two opposite sides. FIG. 7B is a room unit with a segmental arch roof. FIG. 7C is a loft unit with pointed arch roof and short walls on two opposite sides. FIG. 7D is a loft unit with a curved lean-to roof and a short wall on one side. FIG. 7E is a loft unit with a quadrant shaped roof which connects with the floor on one side, with increased height capacity using FIG. 1D (dotted).

FIG. 8A to FIG. 8E are perspective views of dormer windows which can be placed on loft units to improve natural lighting and ventilation. FIG. 8A is a lean-to dormer. FIG. 8B is a gable dormer. FIG. 8C is a flat dormer. FIG. 8D is a hip dormer, and FIG. 8E is a curved dormer.

FIG. 9A to FIG. 9B are examples of prior art showing cross sections through an older historic building and a contemporary building respectively.

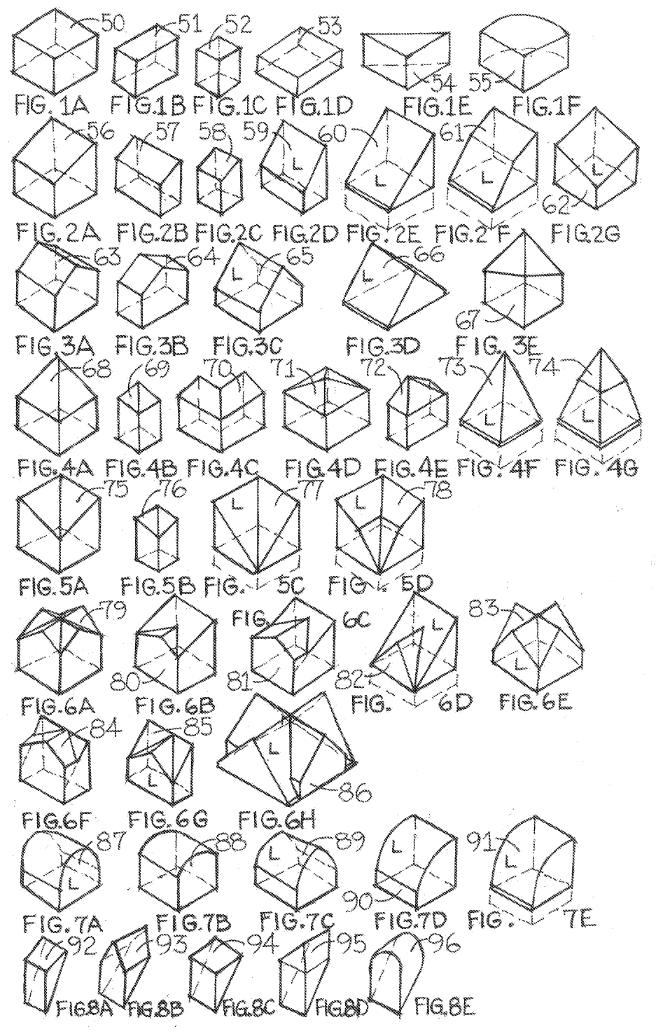

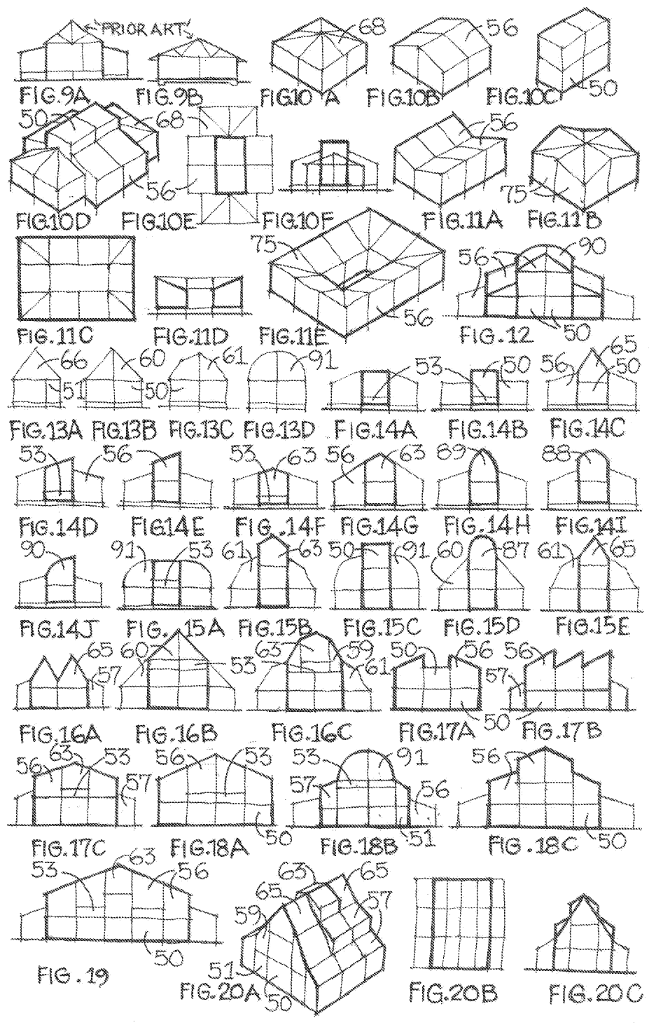

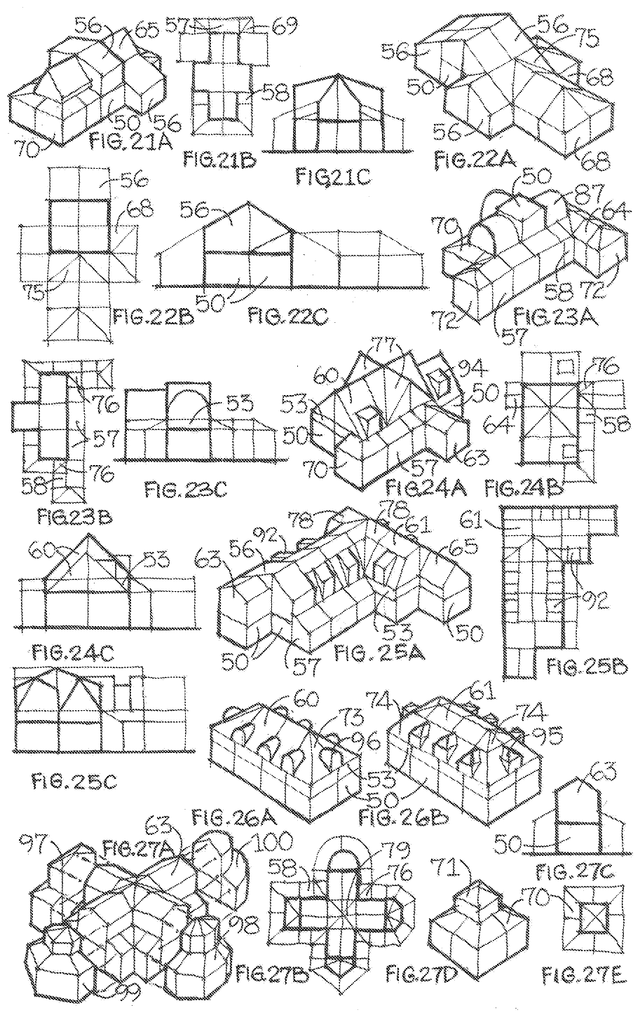

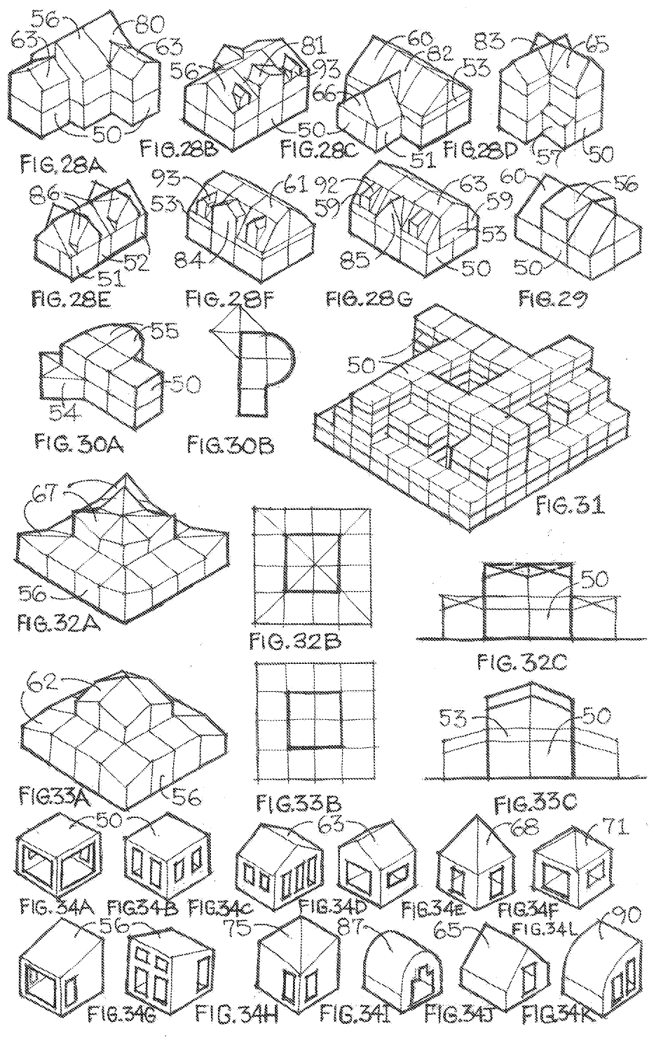

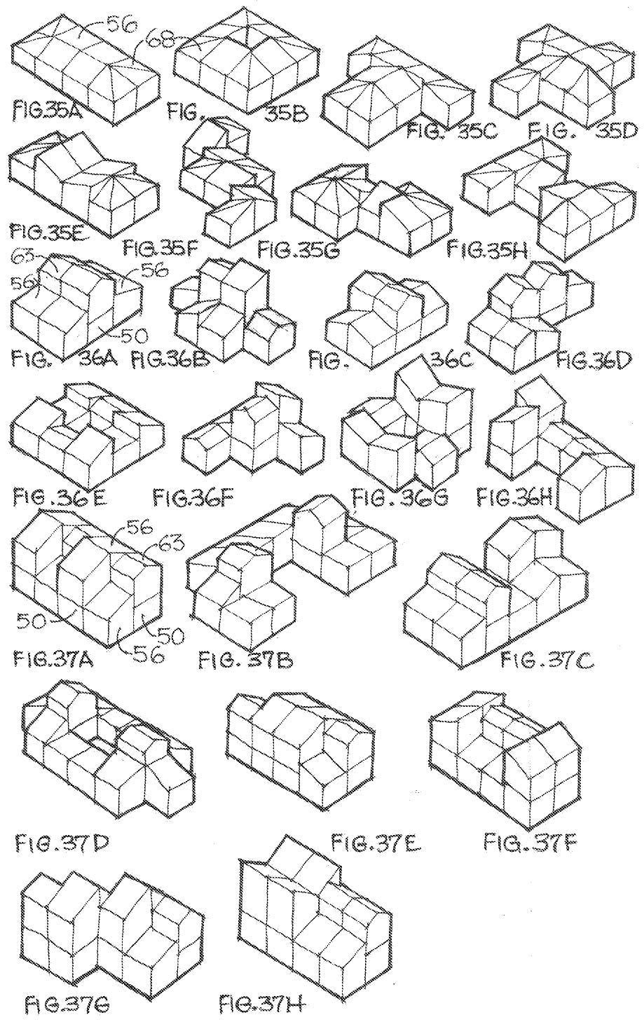

The following drawings illustrate embodiments of the invention by giving examples of assembled model buildings showing, by use of reference numerals, how each of the units in the parts library can be combined using perspective views, top views, and cross section relationship diagrams to describe the models. A cross section relationship diagram shows multiple sections through the model at the same time. FIG. 10A to FIG. 12 gives a summary of the invention showing how particular units selected from the parts library can be combined to form core, non-core, and combination core/non-core models and how by increasing the height of the roof eaves to form a core, a building can grow incrementally.

FIG. 13A to FIG. 19 are two dimensional cross section relationship diagrams of buildings of simple prismatic form which show how units can be combined to produce buildings with non-core, a single room width core or multiple room width cores with the majority flanked by non-core add-on units. The cores are given a heavy outline to distinguish them from the non-core add-on units. Alternatively, the add-on units could be shown on only one side of the core as a staged construction.

FIG. 13A to FIG. 13D are one and a half storey non-core buildings. FIG. 14A to FIG. 14J are one to one and a half storey single core buildings, FIG. 15A to FIG. 15E are two to three storey single room width core buildings, FIG. 16A to FIG. 16C are one and a half to two and a half storey double room width core buildings, FIG. 17A to FIG. 17C are two storey triple room width core buildings, FIG. 18A to FIG. 18C are two to three storey four rooms wide core buildings, and FIG. 19 is a three storey five rooms wide core building.

FIG. 20A to FIG. 27E are more complex 3D models made from a larger selection of units. FIG. 20A to FIG. 20C is a perspective view, top view and cross section diagram of a three storey barn type building comprising three 2D assembles stacked in line with a two room wide core and a medium to steep multi pitch roof. Flanked by non-core add-ons.

FIG. 21A to FIG. 21C is a perspective view, top view and section diagram of a two storey building with a cross shaped core almost surrounded by non-core add-ons and a low to steep multi pitch roof.

FIG. 22A to FIG. 22.C is a perspective view, top view and cross section diagram respectively of a two storey building with square core and medium mono pitch roof with non-core add-ons and extensions.

FIG. 23A to FIG. 23C is a perspective view, top view and section of a diagram of a two storey building with a ‘T’ shaped core almost completely surrounded by add-ons and a variety of roof types including curved barrel loft.

FIG. 24A to FIG. 24B is a perspective view, top view and section diagram respectively of a one and a half storey building with a high multi pitch roof with dormers, a rectangular core footprint and non-core add-ons and extensions.

FIG. 25A to FIG. 25C shows a perspective view, top view, and section diagram of a two storey building with a compound multi pitch, gambrel roof with cross gable and dormers and an ‘L’ shaped core with core extensions as well as non-core add-ons.

FIG. 26A to FIG. 26B showing perspective views of a one and a half storey high pitch hipped roof core building with dormers and a compound ‘mansard’ roofed core building with dormers respectively. Both buildings have height extender units.

FIG. 27A to FIG. 27E show a perspective view, top views and section diagram of a two storey medium pitch gable roofed building with a cross shaped core surrounded by add-on units. The ends of the cross are terminated by hip two storey core add-ons with non-core lower pent roofs. A simple example of a pavilion with a two storey core pyramid roofed core surrounded by non-core ‘wrap around’ add-on units which has a similar section diagram to FIG. 27A is also shown.

FIG. 28A to FIG. 28G are perspective views of modelling assemblies which have intersecting roofs showing how the apparatus cross units FIG. 6A to FIG. 6H can be incorporated in a model. FIG. 28A is a core assembly with core extensions. FIG. 28B is a core assembly of a one and a half storey core intersecting a two storey core. FIG. 28C is a steep pitched gable non-core loft intersecting a core high pitch gable loft. FIG. 28D is a two and a half storey ‘L’ shaped core. FIG. 28E shows two one and a half storey steep gable core assemblies intersecting a non-core one and a half storey ‘A’ frame steep gable loft. FIG. 28F is a core one and a half storey gambrel intersected by a two storey gable core. FIG. 28G is a one and a half storey gambrel core intersected by a one and a half storey steep gable core.

FIG. 29 is a perspective view of a low pitch two storeyed gable core with a one and a half storey high pitched no core gable extension at opposite ends.

FIG. 30A and FIG. 30B are a perspective view and top view of an assembly with three types of flat room units.

FIG. 31 is a perspective view of a large scale core/non-core structure using a plurality of only one type of unit representing a flat structural bay module.

FIG. 32A to FIG. 32C is a perspective view, top view, and section diagram respectively showing a diagonally truncated cuboid room unit with a gable roof used in a core/non-core assembly.

FIG. 33A to FIG. 33C is a perspective view, top view, and section diagram respectively, showing a diagonally truncated cuboid loft unit with a lean-to roof, used in a combination core/non-core assembly.

FIG. 34A to FIG. 34K are perspective views of room and loft units with various possible wall openings which can vary from wall to wall so that by rotating the unit a different arrangement will present itself. FIG. 34A and FIG. 34B are the same flat room unit rotated. FIG. 34C and FIG. 34D are the same gable unit rotated and FIG. 34G are the same lean-to unit rotated.

FIG. 35A to FIG. 35H are perspective views of eight different non-core configurations of the same two types of room units consisting of four lean-to and four hip units.

FIG. 36A to FIG. 36H are perspective views of seven different combination core/non-core configurations and one non-core configuration using eight room units of three types.

FIG. 37A to FIG. 37H are perspective views of eight different core/non-core combination configurations using fourteen room units of three types.

### DESCRIPTION OF EMBODIMENTS

FIG. 9A and FIG. 9B are prior art examples of past and present building practices respectively. FIG. 9A is a historic building with suspended wooden floor, high walls, high flat ceiling and medium pitch hip roof flanked by lean-to additions, which may restrict natural light and ventilation into the main building. This building could possibly be lifted, relocated and recycled but it has unnecessarily high walls and ceilings and the enclosed roof space is wasteful. FIG. 9B is a cross section of a contemporary building with a hip roof, of minimal wall and ceiling height and low overhanging eaves making outward expansion difficult and expensive whilst unnecessary large span trusses between the low pitch roof and flat ceiling prevents easy upward expansion into the wasted roofspace. The concrete floor slab prevents relocation, lifting or recycling.

FIG. 10A to FIG. 12 gives an overview or summary of how this invention works and how units can be combined and reconfigured to produce various alternative options.

FIG. 10A shows four quarter pyramid low pitch hip roof room units 68 combined to form a non-core building with a pyramid roof and low eaves all the way round making it difficult to add onto.

FIG. 10B shows four lean-to low pitch room units 56 combined to form a non-core gable roofed building with low eaves on two sides allowing it to be easily extended on two ends only.

FIG. 10C shows four flat room units 50 combined to form a two storey core building with high roof eaves making it easy to add onto all the way around.

FIG. 10D combines all twelve room units from FIG. 10A, FIG. 10B and FIG. 10C to form a core/non-core assembly in which the dominant two storey core units 50 are flanked by non-core lean-to add-on units 56 forming a three aisled structure in the middle with two hip quarter pyramid roof room units 68 at each end, offset from the main grid. FIG. 10E is a top view showing the four core units 50 in heavy outline, surrounded by eight add-on units 56 and 68 increasing the floor area three times. The add-ons are achieved by simple wall to wall connection causing minimal disruption if built in stages. As alternative options, if the core is removed the central space could become a courtyard or a two storey high enclosed atrium. FIG. 10F is a cross section relationship diagram showing how the different units relate vertically with the two storey core in heavy outline.

FIG. 11A shows six lean-to low pitch roof room units 56 combined to form a no core building with a butterfly roof and internal gutter. Because the lowest part of the roof is internal this building could have add-ons on its two side walls and extensions on its two end walls.

FIG. 11B shows four valley low roof pitch room units 75 combined to form a square non-core building with a cross gable roof which could be easily extended on four sides.

FIG. 11C shows a top view of the combination of units from FIG. 11A and FIG. 11B in the form of a core rectangular courtyard building shown with heavy outline which can be added on to all the way around. FIG. 11D is a cross section relationship diagram of FIG. 11C showing high walls all the way around which makes for easy adding on or extending.

FIG. 11E shows the courtyard building made up of four valley units 75 at the corners with six lean-to units 56 in between.

FIG. 12 is a cross section relationship diagram showing two tiers of add-on units flanking a two and a half storey core with a curved lean-to loft 90. The first tier of add-on units 50 and 56 are two storeys high which makes them part of the four room wide core. The second tier of units are non-core add-ons 56. Making the total number of aisles six and total rooms twelve. Superimposed on this section are two storey flat units 50 or lean-to 56 and flat units 50 which have only six rooms showing that a small increase in the core height can create greater expansion possibilities.

FIG. 13A shows a gable steep pitch ‘A’ frame loft unit 66 which is fifty percent wider than unit 65 but having the same overall height and roof pitch, sitting on top of a flat room unit 50 and a flat half room unit 51 producing a one and a half storey non-core building, one and half rooms wide.

FIG. 13B shows two high pitch lean-to loft units 60 combined to form a gable roof on top of two flat room units 50 producing a non-core building two rooms wide.

FIG. 13C shows two lean-to compound loft units 61 combined to form a gambrel roof on top of two flat ceiling room units 50 producing a non-core building two rooms wide.

FIG. 13D showing two curved quadrant loft units 91 combined to form a semi circular roof on top of two flat ceiling room units 50 producing a non-core building two rooms wide.

FIG. 14A to FIG. 15E are all single width core/non-core combination three aisle structures with core in heavy outline flanked by non-core add-ons. FIG. 14A showing a single room width core having a flat room unit 50 on top of a flat height extender unit 53 flanked by lean-to units 56.

FIG. 14B showing a flat roof room unit 50 on top of a flat height extender unit 53 flanked by non-core add-on flat room units 50.

FIG. 14C shows a gable steep pitch loft unit 65 with short walls on two sides 65 on top of a flat room unit 50 flanked by lean-to low pitch roof room units 56.

FIG. 14D shows a lean-to low pitch roof room unit 56 on top of a flat height extender unit 53 flanked by lean-to low pitch room units 56.

FIG. 14E shows a lean-to low pitch room unit 56 on top of a flat ceiling room unit 50. Forming a single room width core flanked by non-core add-on lean-to low pitch room units 56.

FIG. 14F shows a gable low pitch room unit 63 on top of a flat height extender unit 53 flanked by lean-to low pitch room units 56.

FIG. 14G shows a gable medium pitch room unit 63 on top of a flat ceiling room unit 50 flanked by lean-to medium pitch room units 56.

FIG. 14H shows a pointed arch loft unit 89 on top of a flat ceiling room unit 50 flanked by lean-to low pitch room units 56.

FIG. 14I shows a curved segmental arch room unit 88 on top of a flat ceiling room unit 50 flanked by lean-to low pitch room units 56.

FIG. 14J shows a curved lean-to unit 90 on top of a flat ceiling room unit 50 flanked by lean-to low pitch room units 56.

FIG. 15A shows a flat room unit 50 on top of a flat height extender 53 on top of a flat ceiling room unit 50 flanked by curved quadrant loft units 91 on top of flat ceiling room units 50.

FIG. 15B shows a three storey core with a gable 63 room unit on top of two flat ceiling room units 50 flanked by non-core add-on one and a half storey half gambrel loft units 61 on top of flat ceiling room units 50.

FIG. 15C shows a three storey core of flat room units 50 flanked by one and a half storey add-on curved quadrant loft units 91 on top of flat ceiling units 50.

FIG. 15D shows a two and half storey core with a curved barrel loft unit on top of two flat ceiling room unit 50 flanked by one and half storey high pitch lean-to units 60 on flat ceiling room units 50.

FIG. 15E shows a two and a half storey core with a gable steep pitch loft unit 65 on top of two flat ceiling room units 50 flanked by one and a half storey half gambrel loft units 61 on top of flat ceiling room unit 50.

FIG. 16A shows a two room wide one and a half storey core comprising twin steep gable loft units 65 on top of flat room units 50 flanked by lean-to medium pitch half room units 57.

With reference to FIG. 16B which shows a two room wide two and a half storey core comprising two lean-to high pitch loft units 60 forming a gable roof on top of two flat height extender units 53 on top of four flat room units 50 flanked by one and a half storey add-on lean-to high pitch units 60 on top of flat room units 50.

With reference to FIG. 16C which shows a two room wide two and a half storey high core, made up of a low to medium pitch gable room unit 63 on top of a flat height extender unit 53 flanked by lean-to steep pitch half room loft units 59 all on top of four flat room units 50 flanked by non-core one and a half storey add-on half gambrel units 61 on top of flat room units 50.

FIG. 17A shows a three room wide two storey core made up of two flat room units 50 flanked by lean-to low pitch room units 56 on top of flat room units 50.

FIG. 17B shows a three room wide two storey core made up of three low pitch lean-to room units 56 with sawtooth roof profile on top of flat room units 50 flanked by non-core lean-to half room units 57.

FIG. 17C shows a three room wide two storey core made up of a gable low pitch room unit 63 on top of a flat height extender unit 53 flanked by lean-to low pitch room units 56 all on top of flat room units 50 flanked by non-core lean-to low pitch half room units 57.

FIG. 18A shows a four room wide two storey core, forming a gable roof made up of two lean-to low pitch room units 56 all on top of four flat room units 50 on top of two flat extender units 53 flanked by lean-to low pitch room units 56 all on top of four flat room units 50.

FIG. 18B shows a three room wide two and a half storey core made up of two curved quadrant loft units 91 forming a hemispherical roof on top of flat room height extender units 53 on top of four flat room units 50 flanked by two storey first tier core add-ons consisting of lean-to medium pitch half room units 57 on top of flat half room units 51 flanked by non-core lean-to room units 56.

FIG. 18C shows a four room wide three storey core made up of two lean-to low pitch room units 56 combined to form a gable roof on top of four flat room units 50 flanked by first tier two storey core add-on lean-to low pitch room units 56 on top of flat rooms 50 flanked by non-core second tier lean-to low pitch room units 56.

FIG. 19 shows a five room wide three storey gable roofed core made up of a gable low pitch room unit 63 on top of two flat room units 50 flanked by lean-to low pitch room units 56 on top of flat room height extender units 53 flanked by lean-to low pitch room units 56 all on top of flat room units 50 flanked by non-core lean-to low pitch room units 56.

FIG. 20A shows a barn like more complex 3D structure utilising six different unit types with two room wide core flanked by non-core lean-to medium pitch half room units 57 three bays deep in which each bay has a core of different cross section. The first bay is two and a half storeys with a gable steep pitch loft unit 65 on top of two flat room units 50 flanked by one and a half storey lean-to steep pitch half room loft units 59 on top of flat half room units 51. The second bay is three storeys with a gable medium pitch room unit 63 on top of two flat room units 50 flanked by first tier core add-on lean-to medium pitch half room units 57 on top of flat half room units 51. The third bay is two and a half storeys high with steep gable loft 65 on top of two flat room units 50 flanked by first tier core add-on lean-to medium pitch half room units 57 on top of flat half room units 51.

FIG. 20B shows the barn has a square base with a grid of aisles and bays and a heavy outline showing the rectangular core. FIG. 20C is a cross section relationship diagram combining three sections into one showing core with heavy outline. This could be referred to as horizontal stacking.

FIG. 21A utilises seven different types of units and shows one and a half to two storey building with a core made up of steep gable loft units 65 and low pitch lean-to room units 56 on top of flat room units 50 almost surrounded by add-on lean-to low pitch room units 56 and quarter room units 58 and half room units 57 as well as hip quarter room low pitch units 69 and wraparound hip three quarter room units 70. FIG. 21B shows a plan view of the cross shaped core in heavy outline and a combination of gable, hip and lean-to elements. FIG. 21C is a cross section relationship diagram showing multiple cross sections of the multi pitch roof structure with dropped roof and extended roof add-ons and core in heavy outline.

FIG. 22A utilises four different types of unit and shows a mono pitch roof assembly and a two storey core with gable roof made up of four lean-to medium pitch room units 56 on top of four flat room units 50 flanked by add-on lean-to room units 56 on one side and add-on valley room units 75 on the other side with a gable extension on one side of the valley unit 75, a hip add-on on the other side and an extension cross gable with a terminating hip roof 68 in between and at right angles. Both the hip roof room units 68 and valley roof room units are called add-ons because a part or whole of the roof slopes down at right angles to the core whereas the lean-to room units which slope down parallel to the core are called extensions. The hip roof room units 68 at the end of an extension are called terminals. FIG. 22B shows the top view with square core in heavy outline. FIG. 22C shows cross section relationship diagram with two storey core in heavy outline and the medium pitch roof enables the roof line to be continuous.

FIG. 23A utilises nine different unit types and has a ‘T’ shaped two storey core with three barrel loft units 87 extending from a flat room unit 50 on top of a flat height extender room unit 53 all on top of flat room units 50. The core is surrounded by add-on hip 70 and lean-to half 57 and quarter room 58 units plus two extensions 57 and 64 terminating in hip half pyramid half room units 72. FIG. 23B shows the ‘T’ shaped core in heavy outline. FIG. 23C is the cross sectional diagram showing the core in heavy outline. The flat room unit 50 separating the barrel shaped lofts makes it easier to build without the elaborate vaulting required were they to intersect.

FIG. 24A utilises eleven different unit types and shows a linear rectangular one and a half storey structure with a core made up of four valley high pitched loft units 77 forming a cross gable roof extended as a gable on one end formed by two lean-to high pitched loft units 60, one with a flat roofed dormer 94, all on top of six flat height extender room units 53 on top of six flat room units 50, and on one side of this core are medium pitch non-core add-ons including a hip wraparound three quarter room unit 70 adjoining a lean-to half room unit 57 adjoining a quarter room unit 58 adjoining two valley quarter room units 76, adjoining an extension gable room unit 63, and on the core end is a non-core extension made up of two lean-to high pitched loft units 60, one with a flat dormer 94, forming a gable roofed loft on top of two flat room units 50. FIG. 24B shows the base of the rectangular core in heavy outline and FIG. 24C is a cross section relationship diagram including multiple sections.

Utilising nine different unit types FIG. 25A is a one and a half storey core/non-core combination with two valley compound loft units 78 connected to lean-to half gambrel loft units 61 on two sides to form an ‘L’ shape gambrel roof with lean-to dormers 92, extended at one end into a gable steep pitch loft unit 65 and at the other end into a gable made up of two lean-to units 56 further extending to a gable medium pitch room unit 63 the half gambrel units 61 are on top of flat height extender units and all the units sit on flat room units 50 with small non-core add-on lean-to room units 57 on the inside face of the ‘L’. FIG. 25B shows the core in heavy outline around the ‘L’ shape and extensions. FIG. 25C shows how the gable medium pitch roof unit 63 and steep gable loft unit 65 ‘fit’ neatly inside the two half gambrel units 61 on height extender 53 units and the two lean-to medium pitch room units 56.

Utilising five different unit types FIG. 26A is a one and a half storey core structure with a hip roof made up of lean-to high pitch loft unit 60 and hip quarter pyramid high pitch loft units 73 with curved dormers 96 placed at the joints all on top of flat room height extender units 53 on top of flat room units 50.

Utilising five different unit types FIG. 26B is a one and a half storey core structure with a mansard roof made up of lean-to half gambrel loft units 61 and hip mansard compound loft units 74 with hip dormers placed at the joints all on top of flat height extender room units 53 on top of flat room units 50.

Utilising nine different unit types FIG. 27A shows a mono pitch two storey core/non-core combination cruciform shaped building with the core consisting of four gable medium pitch units 63 extending out from a cross gable medium pitch unit 79 all on top of five flat room units 50 with pent roof add-on units comprising lean-to quarter room units 58 and valley quarter room units 76 forming a three aisled structure in cross section. Each extension is terminated by a variation of a core/non-core combination of a hip roofed top storey above a lower storey with a pent roof. The four variations being rectangular 97, octagonal 98, hexagonal 99 and conical 100. These units can be added to the parts library. FIG. 27B shows a top view with the core in heavy outlining and FIG. 27C is a section showing a core consisting of a gable unit 63 on top of a flat unit 50 flanked by lean-to half room units 58. FIG. 27D shows a two storey pavilion which has a similar section to FIG. 27C except that it is a hip pyramid unit 71 on top of flat unit 50 surrounded by four three quarter room ‘wraparound’ units 70. FIG. 27E is a top view showing the core in heavy outline.

FIG. 28A shows a core two storey building made up of three lean-to low pitch room units 56 and one cross roof unit 80 forming a gable roof on top of four flat room units 50 with a gable unit 63 on flat unit 50 core extension at the end and another identical wing connected to the cross unit on the side.

FIG. 28B is another example of a mono pitch cross gable in which a core two storey building with lean-to medium pitch units forming 56 a gable roof (loft) with shortened walls at the eaves has two cross roof room units 81 back to back in the centre of the side walls with gable dormer windows on either side all on top of six flat room units 50.

FIG. 28C shows a one and a half storey core building with high pitch gable roof formed from five lean-to units 60 and one high pitched cross roof unit 82 on top of height extender units 53 and flat units 50 is joined in a ‘T’ junction to a one and a half storey one and a half rooms wide non-core building with steep pitch ‘A’ frame loft 66 on top of flat unit 50 and flat half room unit 51.

FIG. 28D shows a two and a half storey ‘L’ shaped core/non-core combination building made up of a cross gable steep pitch loft unit 83 from which two gable steep pitch units 65 extend at right angles, all on top of six flat room units 50 with a non-core lean-to add-on half room unit 57 at ground level.

FIG. 28E shows a mono pitch one and a half storey core/non-core combination building made up of two cross roof steep pitch units 86 with one and a half room width sides and each on top of one flat room unit 50, two flat half room units 51 and one flat quarter room unit 52.

FIG. 28F shows a one and a half storey core building with gambrel roof made up of four half gambrel units 61 with gable dormer 93 and in the middle a gable room unit 63 all on flat height extender units on top of flat room units 50. The middle gable flanked by multi pitch gable/lean-to roof unit 84.

FIG. 28G shows a one and a half storey core building with a gambrel roof made up of three gable room units 63 on top of flat height extender units 53 flanked by three lean-to steep pitch loft units 59 on one side and two lean-to steep pitch half room loft units on the other side with a cross roof steep pitch half room unit 85 between and all on top of six flat room units 50.

FIG. 29 shows a two storey central core made up of two lean-to low pitch room units 56 forming a gable roof on top of two flat room units 50 having two non-core extensions from its ends each consisting of two lean-to high pitch loft units 60 on top of two flat room units 50.

FIG. 30A shows a core/non-core combination two storey building. The core is made up of six flat room units 50 and four flat quadrant room units 55 and the non-core part is made up of three flat diagonal room units 54. FIG. 30B shows the core portion in heavy outline and the diagonal non-core portion extending at forty-five degrees angle.

FIG. 31 shows a three storey core/non-core combination building using only one type of unit 53 which could be a larger scale building with structural bays as the design module instead of room sized units. The assembly shows a three storey pinwheel configuration with a central courtyard with two tiers of terrace like units on four sides which could be built in stages and extended as required.

FIG. 32A shows a two storey core/non-core combination structure made up of a central core of four diagonal gable low pitch units 67 on top of four flat room units 50 surrounded by add-on non-core lean-to low pitch room units 56 with diagonal gable units 67 at the corners. FIG. 32B shows a top view with core in heavy outline and FIG. 32C shows a cross section diagram with multiple elevations and sections on the same drawing.

FIG. 33A shows a two storey core/non-core combination structure made up of a central core of four diagonal lean-to low pitch units 62 on top of four flat height extender units 53 on top of four flat room units 50 surrounded by add-on non-core lean-to low pitch room units 56 with diagonal lean-to loft units 62 at the corners. FIG. 33B is a plan view showing a simple grid with core in heavy outline and FIG. 33C is a cross section showing the addition of the flat room height extender unit 53 to increase the height of the core.

FIG. 34A and FIG. 34B show possible openings in the same flat room unit 50 when it is rotated horizontally. This saves making two room units when one can convey two aspects. FIG. 34C and FIG. 34D show the same gable room unit 63 with two different aspects when rotated horizontally. FIG. 34E and FIG. 34F show possible openings in a hip quarter pyramid roofed unit 68 and a hip pyramid roofed unit 71 respectively. FIG. 34G shows possible openings in a lean-to room unit 56 viewed from two directions with the possible inclusion of high level clerestory windows. FIG. 34H to FIG. 34K show possible openings in a valley room unit 75, barrel loft unit 87, steep gable loft unit 65 and curved lean-to loft unit 90 respectively.

FIG. 35A shows a non-core typical so called ‘hip’ roofed building two rooms wide with a rectangular footprint made up of four low pitch lean-to room units 56 and four hip quarter pyramid room units 68. In this description the word hip refers only to the pyramid shaped corner units. FIG. 35B to FIG. 35H are non-core reconfigurations of the same eight room units. FIG. 35B has a courtyard in the centre. FIG. 35C has a ‘T’ shaped layout. FIG. 35D is a pinwheel arrangement. FIG. 35E has a part butterfly roof and internal gutter. FIG. 35F has a square central portion with two offset extensions. FIG. 35G has two square offset portions. FIG. 35J has an ‘H’ shaped layout.

FIG. 36A is a core/non-core combination assembly of eight room units comprising four lean-to units 56 two gable units 63 and two flat room units 50 which resembles an American barn, and FIG. 36B to FIG. 36H are seven of many possible reconfigurations. FIG. 36B has a two storey core with random non-core extensions and add-ons on three sides of the core. FIG. 36C is similar to FIG. 36A except add-ons have been changed to extensions. FIG. 36D has side to side gable on flat two storey core with non-core add-ons and extensions. FIG. 36E is a non-core building with a courtyard. FIG. 36F has a two storey core with non-core add-ons and extensions forming an ‘L’ shape. FIG. 36G has a two storey core with butterfly roof on flat units and a non-core adjacent assembly surrounding a courtyard. FIG. 36H has a two storey lean-to core on flat units with an ‘L’ shape non-core extension.

FIG. 37A shows a core/non-core assembly of fourteen units comprising six lean-to units 56 six flat room units 50 and two gable units 63 in which the building has an eight unit rectangular base while the top floor has two ‘L’ shaped room layouts of six units conjoined. FIG. 37B to FIG. 37H are seven of many possible reconfigurations of FIG. 37A. FIG. 37B is a ‘U’ shaped configuration with two separate two storey single room cores. FIG. 37C has a rectangular base with two separate double room two storey cores. FIG. 37D has a courtyard with two separate two storey single room footprint cores. FIG. 37E has a rectangular base and four roomed core with two core gable extensions. FIG. 37F has a six room ‘U’ shaped core on top of an eight roomed rectangular base. FIG. 37H has a four room butterfly shaped core with a double gable extension on top of an eight unit rectangular base.

There is thus provided a modelmaking system which permits the user to select a plurality of appropriate freestanding predesigned 3D space defining forms from a comprehensive parts library apparatus, and then to design a building by the process of assembling these forms to make an accurate model. The model can be easily modified as the design evolves and later on can be disassembled for re-use. Good design is about preventing problems rather than trying to fix them afterwards, and designing a building in this context means being able to easily explore alternative design paths as well as providing detailed information and instructions for constructing buildings which are practical to build, affordable, adaptable, economical to maintain and which utilise space and energy efficiently.

### REFERENCE NUMERALS

Unit Description=roof shape/pitch/wall height and shape/room size/room type
50 flat/very low/full height/full/room
51 flat/very low/full height/half/room
52 flat/very low/full height/quarter/room
53 flat/very low/short/full/height extender
54 flat/very low/full height diagonal/half/room
55 flat/very low/full height curved/almost full/room
56 lean-to/low to medium/full height/full/room
57 lean-to/low to medium/full height/half/room
58 lean-to/low to medium/full height/quarter/room
59 lean-to/steep/short/half/loft
60 lean-to/high/short/full/loft
61 lean-to/compound/short/full/loft
62 lean-to diagonal/low/short/full/loft
63 gable/low to medium/full height/full/room
64 gable/low to medium/full height/half/room
65 gable/steep/short/full/loft
66 gable A frame/steep/short/larger/loft
67 gable diagonal/low to medium/full height/full/room
68 hip quarter pyramid/low to medium/full height/full/room
69 hip quarter pyramid/low to medium/full height/quarter/room
70 hip quarter pyramid/low to medium/full height/three quarter/room
71 hip pyramid/low to medium/full height/full/room
72 hip half pyramid/low to medium/full height/half/room
73 hip quarter pyramid/high/short/full/loft
74 hip quarter pyramid/compound/short/full/loft
75 valley/low to medium/full height/full/room

### REFERENCE NUMERALS CONTINUED

Unit Description=roof shape/pitch/wall height and shape/room size/room type
76 valley/low to medium/full height/quarter/room
77 valley/high/short/full/loft
78 valley/compound/short/full/loft
79 cross gable/low to medium/full height/full/room
80 cross gable lean-to/low/full height/full/room
81 cross gable lean-to/medium/full height/full/room
82 cross gable lean-to/high/short/full/loft
83 cross gable/steep/short/full/loft
84 cross gable lean-to/medium to steep/full height/half/room
85 cross gable lean-to/steep/short/half/loft
86 cross gable A frame/steep/short/larger/loft
87 curved barrel/not applicable/short/full/loft
88 curved segmental arch/not applicable/full height/full/room
89 curved pointed arch/not applicable/short/full/loft
90 curved lean-to/not applicable/short/full/loft
91 curved lean-to/quadrant/not applicable/short/full/loft
92 lean-to roof dormer
93 gable roof dormer
94 flat roof dormer
95 hip roof dormer
96 curved roof dormer
97 terminal two storey rectangular hip with pent roof
98 terminal two storey octagonal hip with pent roof
99 terminal two storey hexagonal hip with pent roof
100 terminal two storey conical roof with pent roof

1. Modelmaking system for designing buildings comprising:
(a) a parts library apparatus including a plurality of individual scale model three dimensional box like space defining forms representing modest room sized units, each unit complete with square or rectangular floor, walls at right angles to the floor and a roof with a shape selected from the group containing a flat shape, a lean to shape, a gable shape, a hip shape, a valley shape, and a cross roof shape, together with a roof pitch selected from the group containing very low pitch, low pitch, medium pitch, high pitch, and steep pitch, said units being further categorised as either room units with optional flat or raking ceilings, very low to medium pitched roofs, and full height walls at least one storey high, or loft units with raking ceilings and medium to steep pitched roofs, the lowest parts of which connect either to short walls or directly to the floor on at least one side or corner;
(b) three types of unit assembly of which
(1) is a non core unit assembly of maximum height one and a half storeys, in which the lowest part of the roof is about one storey or less above ground level on at least one side of said assembly;
(2) is a core unit assembly in which the external walls are at least sufficiently high all the way around to easily accommodate non core add ons and non core extensions by wall to wall surface contact;
(3) is a combination of core and non core assemblies; and
(c) a kit of parts including a plurality of at least one type of said unit selected by a user from said parts library and assembled according to at least one of said three types of unit assembly to produce at least one model building and building design.

2. Modelmaking system apparatus according to claim 1, further including part room and multiple room sized units, the group comprising quarter room, half room, and three quarter room sized units, and one and a half room and two and a quarter room sized units, which are vertical subdivisions and multiples respectively, of the basic horizontal module, the modest room sized unit.

3. Modelmaking system apparatus according to claim 1, further including a flat room height extender unit with variable height short walls.

4. Modelmaking system apparatus according to claim 1 further including the following units with additional or alternative features;
(a) half room unit with diagonal wall and unit with quadrant wall in the flat roof category;
(b) half gambrel compound roof loft unit in the lean to roof category together with related compound roof loft units in the hip roof and valley roof categories;
(c) diagonally truncated cuboid low pitched loft unit in the lean to roof category and diagonally truncated cuboid room unit in the gable roof category;
(d) pyramid, half pyramid, and truncated pyramid roof units with polygon bases in the quarter pyramid hip roof category; and
(e) units with gable roofs intersecting lean to roofs in the cross roof category.

5. Modelmaking system apparatus according to claim 1, further including units with roofs categorised as curved, the group comprising a barrel loft unit, a segmental arch room unit, a pointed arch loft unit, a lean to loft unit, and a quadrant lean to loft unit.

6. Modelmaking system apparatus according to claim 1, further including a range of dormer window roof accessory units for medium to steep pitched roofs, with roof shapes of the group comprising a flat shape, a lean to shape, a gable shape, a hip shape, and a curved shape.

7. Modelmaking system apparatus according to claim 1 in which the system is modular with the horizontal module based on a modest sized room for smaller buildings or a structural bay for larger buildings and the vertical module is a modest floor to floor height of one storey.

8. Modelmaking system apparatus according to claim 1, in which the approximate roof pitches range from very low, about five degrees; to low, about fifteen degrees; to medium, about thirty degrees; to high, about forty five degrees; to steep, about fifty five degrees.

9. Modelmaking system apparatus according to claim 1, in which the units are hollow box like forms with wall openings for windows, doors, and other apertures, which can vary on different sides of said units.

10. Modelmaking system apparatus according to claim 1, wherein in use, in the assembled condition, the independent freestanding units, are unconnected, contiguous, and able to be stacked horizontally, wall to wall, and vertically from ground or base level, one on top of another up to roof level.

11. Modelmaking system apparatus according to claim 1 in which, in a combination unit assembly, a plurality of non core add on units with at least part or all of their roofs sloping down and away at right angles to a core wall, can partially or completely surround the core assembly whereas non core extension units which project out at right angles from said core wall with a roof which slopes down parallel to said core wall cannot surround said core assembly.

12. Modelmaking system apparatus according to claim 1 in which the unit floors and walls inside an assembled model building represent a modular grid of aisles and bays with load bearing columns at or near the interior corners of units but they do not necessarily determine the actual placement of walls, floors, columns, and beams and may be used as a guide for the intended structure and floor plan arrangement.

13. Modelmaking system apparatus according to claim 1 in which roofs of units are shown without overhangs although they are permitted and depending on the purpose of the model and how the units are manufactured they may be incorporated as an additional refinement.

14. Modelmaking system apparatus according to claim 1 in which the units may be manufactured by lasercutting a material selected from the group containing wood, plywood, metal, cardboard and paper and foam or by plastic injection mould or 3D printing.

15. Modelmaking system for designing buildings according to claim 1, in which the parts library apparatus and assembly process may be provided in the form of virtual entities in a computer program.

16. A method of making model buildings and building designs, the method including:
(a) providing a parts library apparatus including a plurality of individual three dimensional box like forms, representing modest room sized units, each complete with square or rectangular floor, walls at right angles to the floor, and a roof with a shape selected from the group containing a flat shape, a lean to shape, a gable shape, a hip shape, a valley shape, and a cross roof shape, together with a roof pitch selected from the group containing, a very low pitch, low pitch, medium pitch, high pitch, and steep pitch, said units may be further categorised as either room units with optional flat or raking ceilings, very low to medium pitch roofs, and full height walls at least one storey high, or loft units with raking ceilings, and medium to steep pitched roofs, the lowest parts of which connect either to short walls or directly to the floor on at least one side or corner;
(b) selecting a kit of parts from the parts library apparatus comprising a plurality of at least one type of unit; and
(c) assembling the units to produce at least one model building and building design including the structure and building envelope referred to as the shell.
